(19) United States
(12) Patent Application Publication
(10) Pub. No.: US 2013/0065143 A1
(43) Pub. Date: Mar. 14, 2013

(54) METHOD FOR PRODUCING ENERGY, AND THE USE OF A SUBSTANCE MIXTURE FOR PRODUCING ENERGY

(71) Applicants: Ronny Knepple, Ueberlingen (DE); Bernd Speth, Ueberlingen (DE); Franz Tichy, Eppertshausen (DE)

(72) Inventors: Ronny Knepple, Ueberlingen (DE); Bernd Speth, Ueberlingen (DE); Franz Tichy, Eppertshausen (DE)

(73) Assignee: DIEHL AEROSPACE GMBH, Uberlingen (DE)

(21) Appl. No.: 13/699,539

(22) PCT Filed: May 14, 2011
(86) PCT No.: PCT/EP11/02397

§ 371 Date: Nov. 21, 2012

(30) Foreign Application Priority Data
May 25, 2010 (DE) 10 2010 021 443.4
Oct. 27, 2010 (DE) 10 2010 049 794.0

(51) Int. Cl. H01M 8/06

(52) U.S. Cl. CPC H01M 8/06
USPC 429/423; 429/416

(57) ABSTRACT

The present invention relates, in particular, to a process for generating energy, which comprises the following steps:
provision or production of a propylene glycol/water mixture having a propylene glycol content of from 30% by volume to 94% by volume;
production of hydrogen from the propylene glycol/water mixture, in particular by means of reforming; and
conversion of the hydrogen into energy, in particular electric and/or heat energy, in particular by means of a converter by oxidation of the hydrogen, in particular in an electrochemical element, in particular a fuel cell.

The invention relates to a process for generating energy and the use of a mixture of materials for generating energy.

Production of hydrogen by reforming a reforming liquid and converting this hydrogen into electric power by means of fuel cells, for example, is known for energy generation. DE 10 2005 046 746 A1 discloses, for example, a process in which water is firstly electrolytically decomposed into hydrogen and oxygen and a reforming liquid is subsequently synthesized from carbon dioxide and/or carbon monoxide and water. The reforming liquid synthesized can be, for example, an alcohol such as propylene glycol and others.

It is an object of the invention to provide an alternative process for generating energy. The use of a mixture of materials for generating energy should also be indicated.

This object is achieved by claims 1 and 8. Embodiments are defined in the dependent claims.

Claim 1 provides a process for generating energy, which comprises the following steps:
provision or production of a propylene glycol/water mixture having a propylene glycol content of from 30% by volume to 94% by volume;
production of a secondary energy carrier, in particular hydrogen and/or carbon monoxide, from the propylene glycol/water mixture, in particular by means of reforming; and
conversion of the secondary energy carrier into energy, in particular electric and/or heat energy, in particular by means of a converter by oxidative reaction of the secondary energy carrier, in particular in an electrochemical element, in particular a fuel cell,

In the process proposed, a propylene glycol/water mixture in the concentration range indicated is used as energy carrier, i.e. as primary energy carrier. The propylene glycol/water mixture is comparatively simple to handle. This is because, as a liquid, it can be kept in stock in a simple way, e.g. in a tank provided for this purpose, with, in particular, refilling of the tank being possible without problems. The propylene glycol/water mixture is as good as nontoxic and biodegradable, as a result of which complicated protective measures for human beings and nature can be dispensed with. Furthermore, the flammability of the propylene glycol/water mixture in the concentration range indicated is at least limited, as a result of which the process can be used universally, especially in regions in which a low flammability is desirable, in regions or environments where there is a risk of ignition and in regions in which there are strict restrictions and obligations in respect of flammability.

The process proposed is environmentally friendly, in any case having little effect on the environment, and is suitable both for mobile and portable and also stationary power generation.

Due to the advantageous properties mentioned, the process can be employed in a wide variety of fields, in particular in mobile power or energy supply devices, e.g. in transport of people, in particular in air travel, in particular in aircraft.

As secondary energy carrier, it is possible, as mentioned above, to produce hydrogen and/or carbon monoxide. Hydrogen can, for example, be converted into electric power and/or heat in conventional high- or low-temperature polymer electrolyte fuel cells (PEMFC). In solid oxide fuel cells (SOFC), both hydrogen and carbon monoxide can be reacted as secondary energy carriers. SOFCs may make it possible to react the secondary energy carriers, in particular hydrogen and carbon monoxide, directly, i.e. to convert them into electric power and/or heat. Here, react directly is intended to mean that no external reformer, as is necessary, for example, in the case of PEMFCs, is required in addition to the fuel cell.

Preference is given to using a propylene glycol/water mixture which has a propylene glycol content of from 30% by volume to 56% by volume, from 56% by volume to 60% by volume, from 60% by volume to 70% by volume, from 70% by volume to 80% by volume and/or from 80% by volume to 94% by volume. It should be pointed out that, in particular, all concentration ranges formed by the above range limits are possible. The concentration ranges indicated have, in particular, the following advantages:

Propylene glycol/water mixtures in the concentration range from 56% by volume to 60% by volume, in which the water brings about a total ignition inhibition, are already approved in air travel, so that such mixtures can be used for energy supply in aircraft without further measures having to be undertaken.

The ignition-inhibiting effect of water continues up to a concentration range of up to 80% by volume. Such mixtures can therefore be employed with the required ignition inhibition without further measures having to be undertaken.

Although the ignition-inhibiting effect of water is somewhat limited in the concentration range from 80% by volume to 94% by volume, compared to other energy carrying media such as hydrogen gas, for example, the mixtures proposed are comparatively safe.

In an embodiment of the process, the heat energy evolved in the conversion of the secondary energy carrier, in particular hydrogen and/or carbon monoxide, into energy is used in a supplementary manner in the production of the secondary energy carrier from the propylene glycol/water mixture. The energy required for production of the secondary energy carrier can be considerably reduced by use of the waste heat evolved in the conversion of the hydrogen and/or carbon monoxide. The overall efficiency of the process can be lastingly improved in this way.

The heat energy evolved in the conversion of the secondary energy carrier can, in particular, be introduced into a reformer for producing hydrogen and/or carbon monoxide from the propylene glycol/water mixture. Other uses of the heat energy, for example for heating purposes and the like, are likewise possible.

In a further variant of the process, water and/or water vapor is withdrawn from the offgas formed in the conversion of the hydrogen, which can be water, water vapor or an air/water mixture, at least one feed gas, in particular hydrogen, oxygen, carbon monoxide or corresponding air mixtures, and/or the ambient air by means of at least part of the as yet unreacted propylene glycol/water mixture, by means of a propylene glycol/water mixture having a propylene glycol content of more than 94% or by means of pure propylene glycol. Here, the fact that propylene glycol is hygroscopic is exploited in an advantageous way. The efficiency of the process can be improved still further in, in particular, the drying or dehumidification of a feed gas.

In particular, the abovementioned variant makes it possible to generate or produce a propylene glycol/water mixture in the desired concentration range from more highly concentrated mixtures or pure propylene glycol. This is particularly advantageous in mobile energy supply devices since the proportion of water which also has to be transported can be reduced.

Water or water vapor can be withdrawn from the offgas, feed gas and/or the ambient air by, for example, these being passed through the propylene glycol/water mixture or propylene glycol and/or conveyed past an exchange area, in particular a membrane, which is permeable, preferably selectively, to water or water vapor and is in contact with the propylene glycol/water mixture or the propylene glycol, optionally a plurality of times, or brought into contact therewith.

In an embodiment of the process, the propylene/water mixture, or at least part thereof, can be produced directly from carbon dioxide and/or carbon monoxide, hydrogen and water.

Independent claim 8 relates to the use of a propylene glycol/water mixture having a propylene glycol content of from 30% by volume to 94% by volume for generating energy, in particular electric energy and/or heat energy, by oxidation, in particular by electrochemical reaction, of a secondary energy carrier, in particular hydrogen and/or carbon monoxide, produced from the propylene glycol/water mixture.

Preference is given to using concentration ranges of from 30% by volume to 56% by volume, from 56% by volume to 60% by volume, from 60% by volume to 70% by volume, from 70% by volume to 80% by volume or from 80% by volume to 94% by volume. Compared to fuel cell systems operated using stored hydrogen, a significantly higher energy density, in particular an energy density which is a multiple higher, can be achieved using a propylene glycol/water mixture, which is due, in particular, to the comparatively high specific energy density of propylene glycol. The comparatively high energy densities which can be achieved are extremely advantageous for, in particular, keeping the energy carrier in stock at the point of use, not only in the case of mobile systems. At a given energy consumption, a high energy density also means a comparatively small space requirement for storage and keeping in stock of the primary energy carrier, here the propylene glycol/water mixture. A further advantage, in particular for the air transport sector, for fixed applications on the ground and also for mobile applications, is the low weight due to the high specific energy, i.e. the gravimetric energy density, of propylene glycol.

Furthermore, it is possible for the propylene glycol/water mixture also to be used for withdrawing water or water vapor from the offgas formed in the conversion of the hydrogen, at least one feed gas and/or the ambient air.

As regards advantages and advantageous effects of the use of the propylene glycol/water mixture, reference is made to the information given above in respect of the proposed process.

1. A process for generating energy, which comprises producing
a secondary energy carrier from a propylene glycol/water mixture having a propylene glycol content of from 30% by volume to 94% by volume;
converting the secondary energy carrier into energy.

2. The process as claimed in claim 1, wherein the propylene glycol/water mixture has a propylene glycol content of from 30% by volume to 56% by volume.

3. The process as claimed in claim 1, wherein heat energy evolved in the conversion of the secondary energy carrier is used in a supplementary manner in the production of the secondary energy carrier from the propylene glycol/water mixture.

4. The process as claimed in claim 3, wherein the heat energy is introduced into a reformer for producing the secondary energy carrier from the propylene glycol/water mixture.

5. The process as claimed in claim 1, wherein water or water vapor is withdrawn from the offgas formed in the conversion of the secondary energy carrier, at least one feed gas and/or the ambient air by means of at least part of the as yet unreacted propylene glycol/water mixture, by means of a propylene glycol/water mixture having a propylene glycol content of more than 94% or by means of pure propylene glycol.

6. The process as claimed in claim 5, wherein the offgas, feed gas and/or the ambient air is passed through the propylene glycol/water mixture or propylene glycol and/or is conveyed past an exchange area to water or water vapor and is in contact with the propylene glycol/water mixture or the propylene glycol or brought into contact therewith.

7. The process as claimed in claim 1, wherein the propylene/water mixture is produced directly from carbon dioxide and/or carbon monoxide, hydrogen and water,

8-10. (canceled)

11. The process according to claim 1, wherein said secondary energy carrier is hydrogen and/or carbon monoxide.

12. The process according to claim 1, wherein said secondary energy carrier is produced by means of reforming.

13. The process according to claim 1, wherein said energy carrier is electric and/or heat energy,

14. The process according to claim 1, wherein said secondary energy carrier is converted into energy by means of a converter by oxidation of the hydrogen and/or carbon monoxide.

15. The process according to claim 14, wherein said converter is an electrochemical element.

16. The process according to claim 15, wherein said electrochemical element is a fuel cell.

17. The process according to claim 1, wherein the propylene glycol/water mixture has a propylene glycol content of from 56% by volume to 60% by volume.

18. The process according to claim 1, wherein the propylene glycol/water mixture has a propylene glycol content of from 60% by volume to 70% by volume.

19. The process according to claim 1, wherein the propylene glycol/water mixture has a propylene glycol content of from 70% by volume to 80% by volume.

20. The process according to claim 1, wherein the propylene glycol/water mixture has a propylene glycol content of from 80% by volume to 94% by volume.
